(19) United States
(12) Patent Application Publication
(10) Pub. No.: US 2020/0364964 A1
(43) Pub. Date: Nov. 19, 2020

(54) Device for handling notes of value and method for operating a device for handling notes of value

(71) Applicant: Wincor Nixdorf International GmbH, Pderborn (DE)

(72) Inventor: Hermann HÖSCHEN, Paderborn (DE)

(21) Appl. No.: 15/931,117

(22) Filed: Jul. 16, 2020

(30) Foreign Application Priority Data
May 14, 2019 (EP) 19174321.0

(51) Int. Cl. G07D 11/13; G07F 7/04

(52) U.S. Cl. CPC G07D 11/13; G07F 7/04

(57) ABSTRACT

Shown is a device (10) for handling notes of value, with an input/output compartment (14), a pull-off and separating device (16), an intermediate storage unit (18) comprising a drum storage (20), at least one cash box (22), a transport device (24) for the transport of notes of value between the afore-mentioned units, and a control unit (26). The control unit (26) is configured to control the transport device (24) such that notes of value that are to be stored in the cash box (22) are fed to the drum storage (20) and are intermediately stored thereat, and these notes of value are again taken from the intermediate storage unit (18) after receipt of a confirmation information, are fed to the cash box (22) and are stored therein.

### CROSS-REFERENCE TO RELATED APPLICATIONS

This application claims priority to and the benefit of EP19174321.0, which was filed on May 14, 2019.

### BACKGROUND AND SUMMARY

The invention relates to a device for handling notes of value with an input/output compartment, a pull-off and separating device, an intermediate storage unit comprising a drum storage, at least one cash box, a transport device for the transport of notes of value between the afore-mentioned units, and a control unit. The control unit is configured to control the transport device such that notes of value that are to be stored in the cash box are fed to the drum storage and are intermediately stored thereat, and these notes of value are again removed from the intermediate storage unit after receipt of a confirmation information, are fed to the cash box and stored therein.

The invention further relates to a method for operating a device for handling notes of value, in which notes of value provided to the device via an input/output compartment are separated, the separated notes of value are identified and checked for at least one safety feature. All checked notes of value are fed to a drum storage of an intermediate storage unit and are intermediately stored thereat. Notes of value that have been checked positive for the safety feature are taken from the drum storage, fed to a cash box and stored therein.

Known devices for handling notes of value have so-called retract compartments for storing non-removed notes of value. When, for example, notes of value to be dispensed have not or not completely been removed, these are transported back to the device and stored in one of the retract compartments. Here, it is necessary to store the non-removed notes of value physically separated from other notes of value so that the non-removed notes of value may be assigned in an unambiguous manner later on because an account had already been debited with the amount of the notes of value transported to the input/output compartment. At present, however, at most two to three such retracts may be performed because in known devices only a limited amount of retract compartments is available. After two or three retract transactions, the device is no longer operational. Further, the provision of retract compartments requires relatively much installation space which is already scarce in most devices for handling notes of value anyway.

Document DE 10 2011 000 797 A1 discloses a device for handling notes of value with two intermediate storages for intermediately storing the notes of value. The device comprises a sensor unit for determining at least one feature of each note of value and a switch which feeds the respective note of value to the one or the other intermediate storage depending on the determined feature.

From document DE 10 2010 036 571 A1, a method for depositing notes of value into a device for handling notes of value with a virtual intermediate storage is known. Here, two value note storages arranged in a safe are used as a virtual intermediate storage.

Document DE 10 2006 058 549 A1 discloses a device for handling banknotes with an intermediate storage for intermediately storing banknotes. The intermediate storage comprises several transport elements which form an endless transport path for intermediately storing banknotes fed to the device.

Document DE 10 2010 016 810 A1 discloses a device for intermediately storing at least one value note container.

It is the object of the invention to specify a device for handling notes of value and a method for operating such a device, in which several retracts may easily be handled.

This object is solved by a device having the features of claim 1 and a method having the features of claim 6. Advantageous developments are specified in the dependent claims.

In the device according to claim 1, the control unit is configured to control the transport device such that notes of value which are to be stored separately from notes of value in the cash box are fed to the drum storage and are permanently stored thereat. The control unit is further configured to advance the drum storage, after storing the notes of value to be permanently stored, such that a safe physical separation between the notes of value to be permanently stored and subsequently intermediately stored notes of value or notes of value to be permanently stored is given.

Drum storages, also referred to as foil storages or winding storages, for storing notes of value usually have two foil belts wound around winding drums, which belts may be wound jointly on one winding drum, the notes of value to be stored being inserted between the foil belts upon winding on the third drum. The storage capacity of such drum storages amounts to several hundred notes of value. Thus, it is possible to store a large number of retracted notes of value in the drum storage. Compared to conventional retract compartments, the drum storage further has the advantage that a retract compartment is fully occupied even in the case of a retract of only one note of value, while such a retract hardly reduces the storage capacity of the drum storage. Since retracts usually only comprise a few notes of value, the use of the drum storage of the intermediate storage enables the storage of a large number of retracts in the drum storage. Thus, the device according to claim 1 remains operational even after several retracts, in particular after more than three retracts.

The drum storage of the device according to claim 1 thus has two functions. On the one hand, it serves as an intermediate storage, also referred to as escrow, for notes of value as long as a confirmation information for a storage in the cash box has not been received yet. On the other hand, it serves as a permanent storage for notes of values which are to be stored separately from notes of value in the cash box. As a result, installation space is saved in the device.

It is advantageous when the device comprises a checking device, and the control unit is configured to control the pull-off and separating device such that notes of value provided to the device via the input/output compartment are separated, and to control the checking device such that the separated notes of value are identified and checked for at least one safety feature. Further, the control unit is configured to control the transport device such that all checked notes of value are fed to the drum storage of the intermediate storage unit and are intermediately stored thereat, and that notes of value that are checked positive for the safety feature are removed from the drum storage and transported to the cash box and stored therein.

In this embodiment, notes of value that have been checked negative for the safety feature, i.e. counterfeit notes of value or notes of value suspected to be counterfeit, are separated from notes of value that have been checked positive for the safety feature, i.e. genuine notes of value. The counterfeit notes of value and the notes of value suspected to be counterfeit should be stored separately from the notes of value in the cash box. The intermediate storage unit thus also serves as a permanent storage for the counterfeit notes of value and the notes of value suspected to be counterfeit. As a result, further installation space is saved in the device. A further advantage of this embodiment is that the counterfeit notes of value and the notes of value suspected to be counterfeit are protected from access in the drum storage. At the same time, however, no safe key is required to remove the counterfeit notes of value or the notes of value suspected to be counterfeit from the device.

Further, it is advantageous when the control unit controls the transport device such that notes of value that have been checked negative for the safety feature are transported from the drum storage to the input/output compartment and are intermediately stored therein. After storing the notes of value that have been checked positive for the safety feature in the cash box, then the notes of value that have been checked negative for the safety feature are transported from the input/output compartment to the drum storage and are permanently stored thereat.

As a result, at first all notes of value are intermediately stored so that a confirmation information may be queried before the notes of value are stored in the cash box. When a negative confirmation information is received, i.e. when for example a deposit operation is to be interrupted, for example only those notes of value that have been checked positive for the safety feature may be transported back to the input/output compartment and provided for output therein. The counterfeit notes of value and the notes of value suspected to be counterfeit are permanently stored in the drum storage in this embodiment. Alternatively, upon receipt of a negative confirmation information all intermediately stored notes of value may be transported back to the input/output compartment and provided for output therein.

Further, it is advantageous when the device comprises the checking device and when the control unit is configured to control the pull-off and separating device such that notes of value provided to the device via the input/output compartment are separated. The control unit is further configured to control the checking device such that the separated notes of value are identified and their respective denomination is determined. The control unit is further configured to control the transport device such that all checked notes of value are fed to a drum storage of an intermediate storage unit and are intermediately stored therein, that notes of value of at least one predetermined denomination are transported from the drum storage to the input/output compartment and are intermediately stored therein, that the remaining notes of value are taken from the drum storage, are transported to the cash box and are stored therein, and that after storing the remaining notes of value in the cash box, the notes of value of the at least one predetermined denomination are transported from the input/output compartment to the drum storage and are permanently stored thereat.

This embodiment makes it possible to permanently store rare denominations, such as 200 Euro or 500 Euro notes. The notes of value of the rare denominations are protected from immediate access in the drum storage, without additional cash boxes or compartments having to be provided in a safe area. As a result, further installation space is saved.

Further, it is advantageous when the control unit is configured to advance the drum storage, after storing the notes of value to be permanently stored, such that the minimum distance between the last note of value of the notes of value to be permanently stored and the first note of value of the subsequently intermediately stored notes of value is three to twenty times, preferably five to ten times a preset minimum distance between two successively stored intermediately stored notes of value so that a safe physical separation between the permanently stored notes of value and the subsequently intermediately stored notes of value exists. As a result, a mixing of the intermediately stored notes of value, for example of a current deposit into the device, with the notes of value to be permanently stored is safely prevented.

In the present application, distance between two notes of value in the drum storage means the distance between two facing edges of two notes of value immediately successively stored in the drum storage. With other words, the distance between two immediately successively stored notes of value is equal to the distance between a rear edge of the note of value first stored in the drum storage and a front edge of the note of value subsequently stored in the drum storage.

In the present application, the minimum distance means the distance which two notes of value at least have to one another. Since notes of value have different sizes, the distance between two notes of value successively stored in the drum storage does not necessarily always have the same value. Keeping the minimum distance between two immediately successive notes of value stored in the drum storage can, for example, be achieved in that the two notes of value are stored in the drum storage such that their front edges or rear edges have a predefined distance to each other.

The invention further relates to a method of the above-mentioned type having the features of claim 6, in which notes of value that have been checked negative for the safety feature are transported from the drum storage to the input/output compartment and are intermediately stored therein. After storing the notes of value that have been checked positive for the safety feature in the cash box, the notes of value that have been checked negative for the safety feature are transported from the input/output compartment to the drum storage and are permanently stored thereat. After permanently storing the notes of value that have been checked negative for the safety feature, the drum storage is then advanced so that a safe physical separation between the permanently stored notes of value and subsequently intermediately stored notes of value is created.

The method has the same advantages as the claimed device and can be developed in the same manner, in particular with the features of the dependent claims.

In a preferred embodiment, the notes of value that have been checked positive for the safety feature are only removed from the drum storage after receipt of a confirmation information, are transported to the cash box and are stored in the cash box.

In a further preferred embodiment, after feeding notes of value to be permanently stored, the drum storage is advanced such that the minimum distance between the last note of value of the notes of value to be permanently stored and the first note of value of the subsequently intermediately stored notes of value is three to twenty times, preferably five to ten times a preset minimum distance between two successively stored intermediately stored notes of value so that a safe physical separation between the permanently stored notes of value and the subsequently intermediately stored notes of value is created.

In an alternative embodiment, after feeding notes of value to be permanently stored, the drum storage is advanced by a predetermined angle, preferably by half a turn or a full turn of the wind-up drum so that a safe physical separation between the notes of value that are permanently stored and the subsequently intermediately stored notes of value is created.

In a further preferred embodiment, notes of value to be dispensed are taken from a cash box of the device and stored in the input/output compartment. After a preset provision time, notes of value remaining in the input/output compartment are transported from the input/output compartment to the intermediate storage unit and are permanently stored thereat. After permanently storing the notes of value that have remained in the input/output compartment in the drum storage, the latter is advanced so that a safe physical separation between the permanently stored notes of value and the successively intermediately stored notes of value is created.

Further features and advantages result from the following description which in connection with the enclosed Figures explains the invention in more detail on the basis of embodiments.

### BRIEF DESCRIPTION OF THE DRAWINGS

In the figures,

FIG. 1 shows a schematic illustration of a device for handling notes of value.

FIG. 2-1 shows a first portion of a flow chart of a sequence for operating the device according to FIG. 1, in which notes of value are fed to the device;

FIG. 2-2 shows a second portion of the flow chart of FIG. 2-1; and

FIG. 3 shows a flow chart of a further sequence for operating the device according to FIG. 1, in which notes of value for withdrawal are provided to the device.

### DETAILED DESCRIPTION

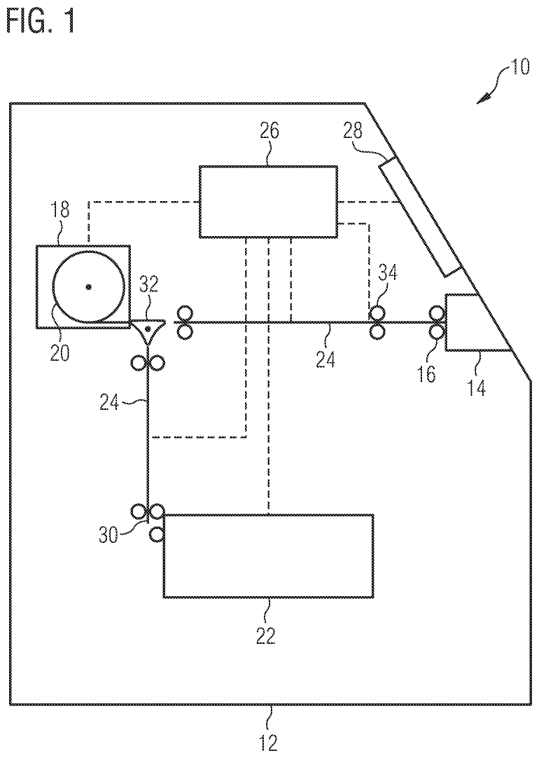

FIG. 1 shows a schematic illustration of a device 10 for handling notes of value. The device 10 comprises a housing 12. Within the housing 12, an input/output compartment 14, a pull-off and separating device 16, an intermediate storage unit 18 comprising a drum storage 20, a cash box 22, a transport device 24 for the transport of notes of value between the afore-mentioned units, and a control unit 26 are arranged. Further, a control panel 28 for the input of a confirmation information is arranged above the input/output compartment 14.

The input/output compartment 14 is connected to the transport device 24 via the pull-off and separating device 16. As a result, notes of value provided to the device 10 via the input/output compartment 14 can be pulled off, separated and transported to the various units of the device 10.

The device 10 comprises a feed and removal unit 30 for the pull-off of notes of value from the cash box 22 and for feeding individual notes of value into the cash box 22.

The transport device 24 comprises a switch 32. The switch 32 is configured to deflect notes of value coming from the input/output compartment 14 either in the direction of the cash box 22 or the intermediate storage 18 as well as notes of value coming from the intermediate storage unit 18 either in the direction of the cash box 22 or the input/output compartment 14. The switch 32 is further configured to deflect notes of value coming from the cash box 22 in the direction of the input/output compartment 14. The transport device further comprises a checking device 34 which is connected to the control unit 26 and configured to identify the separated notes of value, i.e. in particular to determine their denomination, and preferably to check them for at least one safety feature.

The control unit 26 is connected to the intermediate storage unit 18, the cash box 22, the transport device 24 and the control panel 28. The control unit 26 is configured to control the transport device 24 such that notes of value which are to be stored in the cash box 22 are fed to the drum storage of the intermediate storage unit 18 and are intermediately stored thereat, and these notes of value, after receipt of the confirmation information input via the control panel 28, are again removed from the intermediate storage unit 18, are fed to the cash box 22 and are permanently stored therein. The control unit 26 is further configured to control the transport device 24 such that notes of value which are to be stored separately from notes of value in the cash box 22 are fed to the drum storage 20 and are permanently stored thereat, and to advance the drum storage 20, after storage of the notes of value to be permanently stored, such that a safe physical separation between the notes of value to be permanently stored and subsequently intermediately stored notes of value exists. The notes of value to be permanently stored may in particular be counterfeit notes of value or notes of value suspected to be counterfeit or notes of value that have not been taken from the input/output compartment 14.

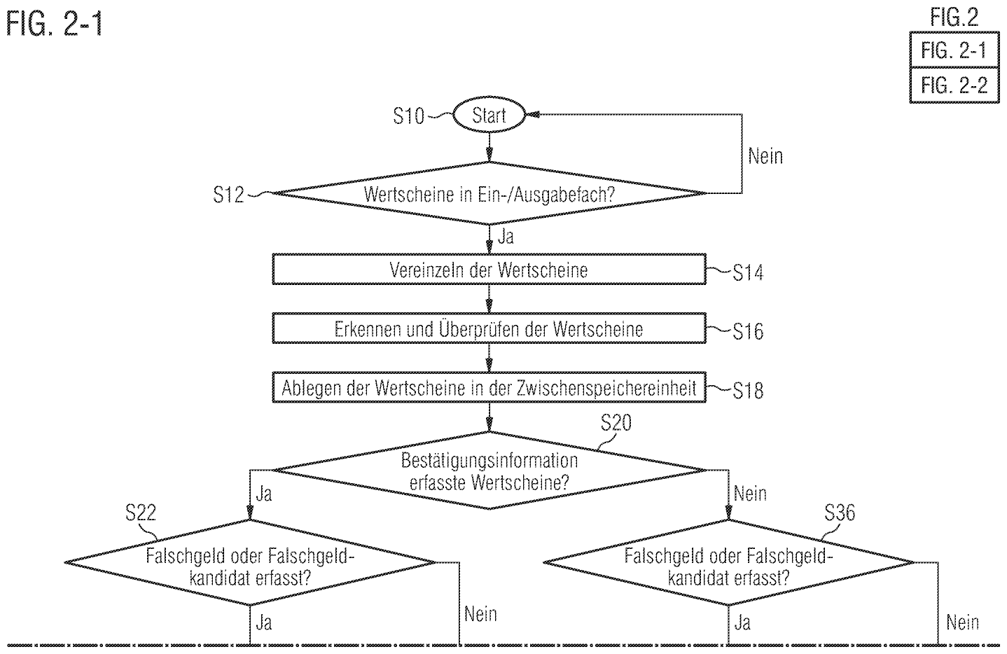

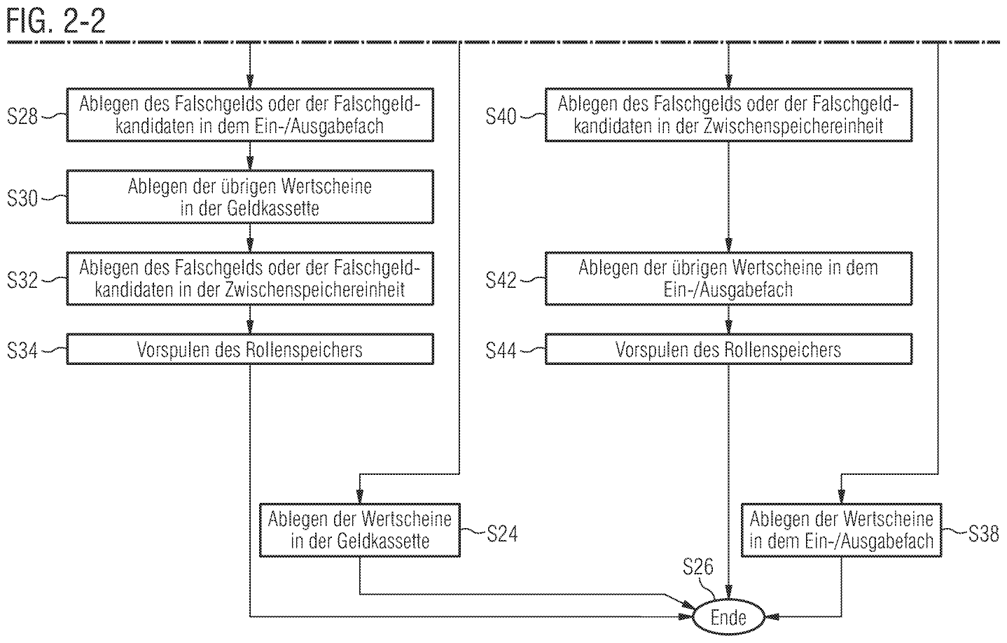

FIG. 2 shows a flow chart of a sequence for operating the device 10 according to FIG. 1, in which notes of value are fed to the device 10 via the input/output compartment 14. Thus, the sequence of FIG. 2 relates to a deposit operation.

The sequence is started in step S10. In a following step S12, it is checked whether a bundle of notes of value to be deposited is present in the input/output compartment 14. If a bundle of notes of value is present, this is separated in step S14. The separated notes of value are individually fed to the checking device 34. The checking device 34 performs a value note identification in step S16 and checks each note of value for at least one safety feature. In step S18, the checked notes of value are individually successively stored in the intermediate storage unit 18.

In step S20, this confirmation information is queried via the control panel 28. This means, for example, that a user is prompted via the control panel 28 to confirm the total amount of the deposited notes of value determined in step S16.

When a positive confirmation information is detected, i.e. the user for example confirms the total amount of the deposited notes of value, then it is checked in step S22 whether in step S16 counterfeit notes of value or notes of value suspected to be counterfeit had been determined among the deposited notes of value. If no counterfeit notes of value or notes of value suspected to be counterfeit had been determined, all deposited notes of value intermediately stored in the drum storage 20 are transported to the cash box 22 by means of the transport device 24 and stored thereat in step S24. Subsequently, the sequence is terminated in step S26.

When among the deposited notes of value counterfeit notes of value or notes of value suspected to be counterfeit had been determined, these are at first, in step S28, intermediately stored in the input/output compartment 14 closed at this point in time. Subsequently, the remaining notes of value are fed to the cash box 22 in step S30 and stored therein. In step S32, the counterfeit notes of value or the notes of value suspected to be counterfeit are transported from the input/output compartment 14 back to the intermediate storage unit 18 and are permanently stored thereat. In step S34, the drum storage 20 is advanced such that a safe physical separation between the notes of value to be permanently stored and subsequently intermediately stored notes of value exists. Subsequently, the sequence is terminated in step S26.

If no confirmation information is detected or if a negative confirmation information is detected, i.e. the user for example does not confirm the value of the deposited notes of value or the user cancels the operation, then it is checked in step S36 whether in step S16 counterfeit notes of value or notes of value suspected to be counterfeit had been determined among the deposited notes of value. If no counterfeit notes of value or notes of value suspected to be counterfeit had been determined, then in step S38 all deposited notes of value intermediately stored in the drum storage 20 are transported to the input/output compartment 14 by means of the transport device 24 and provided thereat for withdrawal. If among the deposited notes of value counterfeit notes of value or notes of value suspected to be counterfeit have been determined, these are permanently stored in the drum storage 20 in step S40. Thereafter, in step S42 the remaining notes of value are taken from the drum storage 20, are transported to the input/output compartment 14 and provided thereat for withdrawal. In step S44, the drum storage 20 is advanced such that a safe physical separation between the notes of value to be permanently stored and subsequently intermediately stored notes of value exists. Subsequently, the sequence is terminated in step S26.

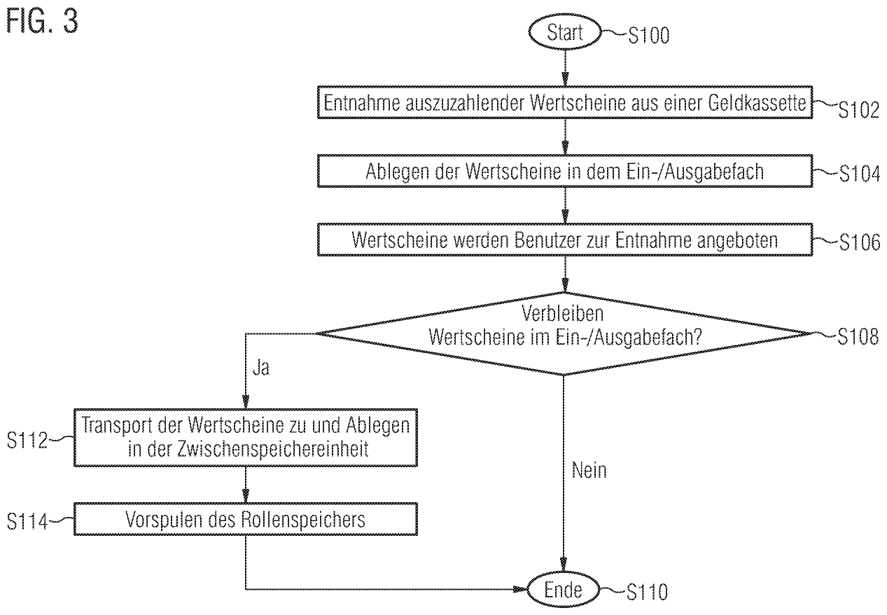

FIG. 3 shows a flow chart of a further sequence for operating the device 10 according to FIG. 1, in which the device 10 provides notes of value for withdrawal. Thus, the sequence of FIG. 3 relates to a withdrawal operation.

The sequence is started in step S100. In a following step S102, notes of value to be dispensed are taken from the cash box 22. These are separated by means of the feed and removal unit 30 and fed to the transport device 24. In step S104, the notes of value to be dispensed are transported to the input/output compartment 14 by means of the transport device 24 and provided thereat for withdrawal from the device 10 in step S106.

After a preset provision time, it is checked in step S108 whether notes of value have remained in the input/output compartment 14. If no notes of value have remained in the input/output compartment 14, the sequence is terminated in step S110. When notes of value have remained in the input/output compartment 14, these are taken from the input/output compartment 14 in step S112, are transported to the intermediate storage unit 18 by the transport device 24 and permanently stored thereat. In step S114, the drum storage 20 is advanced such that a safe physical separation between the notes of value to be permanently stored and subsequently intermediately stored notes of value exists. Subsequently, the sequence is terminated in step S110.

1. A device (10) for handling notes of value, with an input/output compartment (14), a pull-off and separating device (16), an intermediate storage unit comprising a drum storage (20), at least one cash box (22), a transport device for the transport of notes of value between the afore-mentioned units, and a control unit (26),
wherein the control unit (26) is configured to control the transport device (24) such that notes of value which are to be stored in the cash box (22) are fed to the drum storage (20) and are intermediately stored thereat, and these notes of value are again removed from the intermediate storage unit (18) after receipt of a confirmation information, are fed to the cash box (22) and are stored therein,
characterized in that
the control unit (26) is further configured to control the transport device (24) such that notes of value which are to be stored separately from notes of value in the cash box (22) are fed to the drum storage (20) and are permanently stored thereat, and
after storage of the notes of value to be permanently stored, to advance the drum storage (20) such that a safe physical separation between the notes of value to be permanently stored and subsequently intermediately stored notes of value exists.

2. The device (10) according to claim 1, characterized in that the device (10) comprises a checking device (34), and
that the control unit (26) is configured to control the pull-off and separating device (16) such that notes of value provided to the device (10) via the input/output compartment (14) are separated,
to control the checking device (34) such that the separated notes of value are identified and checked for at least one safety feature, and
to control the transport device (24) such that all checked notes of value are fed to a drum storage (20) of an intermediate storage unit (18) and are intermediately stored thereat, and that notes of value that have been checked positive for the safety feature are taken from the drum storage (20), are transported to the cash box (22) and are stored therein.

3. The device (10) according to claim 2, characterized in that the control unit (26) controls the transport device (24) such that notes of value that have been checked negative for the safety feature are transported from the drum storage (20) to the input/output compartment (14) and are intermediately stored therein, and that, after storage of the notes of value that have been checked positive for the safety feature in the cash box (22), the notes of value that have been checked negative for the safety feature are transported from the input/output compartment (14) to the drum storage (20) and are permanently stored thereat.

4. The device (10) according to one of the claims 1 to 3, characterized in that the device (10) comprises a or the checking device (34), and
that the control unit (26) is configured to control the pull-off and separating device (16) such that notes of value provided to the device (10) via the input/output compartment (14) are separated,
to control the checking device (34) such that the separated notes of value are identified and their respective denomination is determined, and
to control the transport device (24) such that all checked notes of value are fed to a drum storage (20) of an intermediate storage unit (18) and are intermediately stored thereat, that notes of value of at least one predetermined denomination are transported from the drum storage (20) to the input/output compartment (14) and are intermediately stored therein, that the remaining notes of value are taken from the drum storage (20), are transported to the cash box (22) and are stored therein, and that, after storage of the other notes of value in the cash box (22), the notes of value of the at least one predetermined denomination are transported from the input/output compartment (14) to the drum storage (20) and are permanently stored thereat.

5. The device (10) according to one of the claims 1 to 4, characterized in that the control unit (26) controls the transport device (24) such that notes of value to be dispensed are taken from the cash box (22) of the device (10),
that the notes of value to be dispensed are stored in the input/output compartment (14), and that notes of value remaining in the input/output compartment (14) after a preset provision time are taken from the input/output compartment (14), are transported to the intermediate storage unit (18) and are permanently stored thereat.

6. The device (10) according to one of the claims 1 to 5, characterized in that the control unit (26) is configured to advance the drum storage (20), after storage of the notes of value to be permanently stored, such that the minimum distance between the last note of value of the notes of value to be permanently stored and the first note of value of the subsequently intermediately stored notes of value is three to twenty times, preferably five to ten times a preset minimum distance between two successively stored intermediately stored notes of value so that a safe physical separation between the permanently stored notes of value and the successively intermediately stored notes of value is created.

7. A method for operating a device (10) for handling notes of value, in which
notes of value provided to the device (10) via an input/output compartment (14) are separated,
the separated notes of value are identified and checked for at least one safety feature,
all checked notes of value are fed to a drum storage (20) of an intermediate storage unit (18) and are intermediately stored thereat, and
notes of value that have been checked positive for the safety feature are fed from the drum storage (20) to a cash box (22) and are stored therein,
characterized in that
notes of value that have been checked negative for the safety feature are transported from the drum storage (20) to the input/output compartment (14) and are intermediately stored therein,
that, after storage of the notes of value that have been checked positive for the safety feature in the cash box (22), the notes of value that have been checked negative for the safety feature are transported from the input/output compartment (14) to the drum storage (20) and are permanently stored thereat, and
that, after the permanent storage of the notes of value that have been checked negative for the safety feature, the drum storage (20) is advanced so that a safe physical separation between the permanently stored notes of value and subsequently intermediately stored notes of value is created.

8. The method according to claim 7, characterized in that the notes of value that have been checked positive for the safety feature are removed from the drum storage (20) only after receipt of a confirmation information, are transported to the cash box (22) and are stored therein.

9. The method according to claim 7 or 8, characterized in that after the feeding of notes of value to be permanently stored, the drum storage (20) is advanced such that the minimum distance between the last note of value of the notes of value to be permanently stored and the first note of value of the subsequently intermediately stored notes of value is three to twenty times, preferably five to ten times a preset minimum distance between two successively stored intermediately stored notes of value so that a safe physical separation between the permanently stored notes of value and the subsequently intermediately stored notes of value is created.

10. The method according to claim 7 or 8, characterized in that after the feeding of notes of value to be permanently stored, the drum storage (20) is advanced by a predetermined angle, preferably by half a turn or a full turn of a wind-up drum so that a safe physical separation between the permanently stored notes of value and the subsequently intermediately stored notes of value is created.

11. The method according to one of the claims 7 to 10, characterized in that notes of value to be dispensed are taken from a cash box (22) of the device (10),
that the notes of value to be dispensed are stored in the input/output compartment (14), that notes of value remaining in the input/output compartment (14) after a preset provision time are transported from the input/output compartment (14) to the intermediate storage unit (18) and are permanently stored thereat, and
that after the permanent storage of the notes of value that have remained in the input/output compartment (14) in the drum storage (20), the latter is advanced so that a safe physical separation between the permanently stored notes of value and the subsequently intermediately stored notes of value is created.
